(19) United States
(12) Patent Application Publication
(10) Pub. No.: US 2019/0077622 A1
(43) Pub. Date: Mar. 14, 2019

(54) SHEET SEPARATING APPARATUS, METHOD FOR SEPARATING SHEET, AND METHOD FOR MANUFACTURING SHEET-SHAPED SECONDARY CELL

(71) Applicant: KABUSHIKI KAISHA NIHON MICRONICS, Tokyo (JP)

(72) Inventors: Hidenori ANDO, Tokyo (JP); Masami SANO, Tokyo (JP)

(21) Appl. No.: 16/081,617

(22) PCT Filed: Feb. 16, 2017
(86) PCT No.: PCT/JP2017/005676

§ 371 Date: Aug. 31, 2018

(30) Foreign Application Priority Data
Mar. 2, 2016 (JP) 2016-040108

(51) Int. Cl. B65H 3/16; G03G 15/00; H01F 7/02

(52) U.S. Cl. CPC B65H 3/16; H01F 7/0205; G03G 15/6502

(57) ABSTRACT

A sheet separating apparatus of the present invention includes a main body portion including a placement face on which a plurality of layered sheets are placed, a convex portion that is protruded from the placement face and on which ends of the sheets are placed, and a magnetic circuit arranged at the main body portion. The magnetic circuit includes a plurality of permanent magnets aligned arranged in line in X direction along the placement face with the same poles of adjacent permanent magnets being faced to each other, first yokes each arranged between the permanent magnets, nonmagnetic members each arranged between the permanent magnets and the sheets, and second yokes each arranged between the nonmagnetic members.

### TECHNICAL FIELD

The present invention relates to a technology that enables sheets to be separated one by one from a layered body.

### BACKGROUND ART

Patent Document 1 discloses a method and an apparatus to separate a layered sheet-shaped magnetic body. In Patent Document 1, separation-use electric magnets are arranged at both ends of the sheet-shaped magnetic body. A partition frame formed of nonmagnetic material is arranged between the sheet-shaped magnetic body and the separation-use electric magnets. The sheet-shaped magnetic body is lifted and separated by intermittently magnetizing the separation-use electric magnets at a predetermined frequency.

Patent Document 2 discloses a system for supplying metal mask sheets. The system of Patent Document 2 includes a sheet cassette in which metal mask sheets and protection sheets are stored as being alternately layered. When a magnet floater approaches to the sheet cassette, the metal mask sheets are separated one by one from the sheet cassette. Then, a conveying apparatus holds a separated metal mask sheet at the uppermost position and conveys the metal mask sheet to another apparatus.

### CITATION LIST

### Patent Literature

Patent Document 1: Japanese Unexamined Patent Application Publication No. 2010-254438

Patent Document 2: Japanese Unexamined Patent Application Publication No. 2014-218328

### SUMMARY OF INVENTION

### Technical Problem

According to Patent Document 2, it is required that the metal mask sheets and the protection sheets are stored in the sheet cassette as being alternatively placed. That is, it is required that operation to sandwich a protection sheet between metal mask sheets is performed to separate the metal mask sheets. In Patent Document 1, it is required that the sheet-shaped magnetic body is placed within the nonmagnetic partition frame to separate the sheet-shaped magnetic body. Thus, according to structures of Patent Documents 1 and 2, there has been a problem that sheets cannot be easily separated one by one from a layered body having a plurality of layered sheets (hereinafter, called a layered body).

In view of the above, an object of the present invention is to provide a technology that enables sheets to be easily separated one by one from a layered body.

### Solution to Problem

A sheet separating apparatus according to an aspect of the present embodiment includes a main body portion including a placement face on which a plurality of layered sheets are placed, a convex portion that is protruded from the placement face and on which ends of the sheets are located, and a magnetic circuit arranged at the main body portion. Here, the magnetic circuit includes a plurality of magnets arranged in line in a first direction along the placement face with the same poles of adjacent magnets being faced to each other, a first yoke arranged at each of both sides of each magnet, a nonmagnetic member arranged at a position corresponding to each first yoke, and a second yoke arranged at a position corresponding to each magnet. According to the above, a single sheet can be easily separated from a layered body.

In the above sheet separating apparatus, the magnets may be permanent magnets, and the second yokes and the nonmagnetic yokes may be arranged movably in the first direction. According to the above, it is possible to easily adjust magnetic force to be generated by the magnetic circuit. Here, a single sheet can be separated from the layered body only by moving the second yokes and the nonmagnetic yokes.

In the above sheet separating apparatus, three or more of the permanent magnets may be arranged in line in the first direction, and magnetic force of the permanent magnet arranged at a center region of the placement face with respect to the first direction may be smaller than magnetic force of the permanent magnet arranged at least at one end region of the placement face. According to the above, sheets can be bent appropriately.

In the above sheet separating apparatus, the magnets may be electric magnets. According to the above, it is possible to easily adjust magnetic force to be generated by the magnetic circuit. Here, a single sheet can be separated only by flowing current to the electric magnets.

A method for separating sheets according to an aspect of the present embodiment using the above sheet separating apparatus includes steps of placing the sheets on the placement face in a state that, with respect to the first direction, the nonmagnetic member is located at a position corresponding to the first yoke and the second yoke is located at a position corresponding to the magnet; and moving the second yokes and the nonmagnetic members so that, with respect to the first direction, the nonmagnetic members are located at positions corresponding to the magnets and the second yokes are located at positions corresponding to the first yokes.

A method for separating sheets according to an aspect of the present embodiment using the above sheet separating apparatus includes steps of placing the sheets on the placement face and flowing a predetermined value of current to the electric magnet. According to the above, a single sheet can be separated only by flowing current to the electric magnets.

In the above method for separating sheets, three or more of the electric magnets may be arranged in line in the first direction and, in the current flowing step, each current flowing to the three or more electric magnets may be set so that magnetic force of the electric magnet arranged at a center region of the placement face with respect to the first direction is smaller than magnetic force of the electric magnet arranged at least at one end region of the placement face. According to the above, sheets can be bent appropriately.

In the above method for separating sheets, numbers of turns of coils of the three or more of electric magnets may be set so that magnetic force of the electric magnet arranged at a center region of the placement face is smaller than magnetic force of the electric magnet arranged at least at one end region of the placement face. According to the above, sheets can be bent appropriately.

A sheet separating apparatus according to an aspect of the present embodiment includes a main body portion including a placement face on which a plurality of layered sheets are placed, and a magnetic circuit housed in the main body portion to be capable of causing magnetic lines to reach the sheets. Here, the magnetic circuit includes a permanent magnet, a first yoke arranged at one end side of the permanent magnet, a second yoke arranged at the other end side of the permanent magnet, a first nonmagnetic member arranged at an upper end side of the permanent magnet, and a second nonmagnetic member arranged at a lower end side of the permanent magnet. According to the above, a single sheet can be easily separated from the layered body.

In the above sheet separating apparatus, the permanent magnet may be rotatable about a rotational axis along a first direction on the placement face.

In the above sheet separating apparatus, the placement face may include an end section on which an end region of the sheets is placed, a center section on which a center region of the sheets is placed, and a taper section formed at a region from the end section to the center section.

A method for separating sheets according to an aspect of the present embodiment using the above sheet separating apparatus includes a first step to place the sheets on the placement face in a state that one pole of the permanent magnet is located at a position corresponding to the first nonmagnetic member and the other pole of the permanent magnet is located at a position corresponding to the second nonmagnetic member, and a second step to move one pole of the permanent magnet to a position corresponding to the first yoke and the other pole of the permanent magnet to at a position corresponding to the second yoke by rotating the permanent magnet about the rotational axis.

A method for manufacturing a sheet-shaped secondary cell according to an aspect of the present embodiment includes steps of separating the sheets with the above method and arranging electrodes at the separated sheet. According to the above, cells can be manufactured at high productivity.

### Advantageous Effects of Invention

According to the present invention, it is possible to provide a technology that enables sheets to be easily separated one by one from a layered body.

### BRIEF DESCRIPTION OF DRAWINGS

FIG. 1 is a side view schematically illustrating a structure of a sheet separating apparatus of a first embodiment;

FIG. 2 is a top view schematically illustrating the structure of the sheet separating apparatus of the first embodiment;

FIG. 3 is a side view schematically illustrating a structure of the sheet separating apparatus in a separated state;

FIG. 4 is a view illustrating magnetic lines generated by a magnetic circuit in a non-separated state;

FIG. 5 is a view illustrating magnetic lines generated by the magnetic circuit in the separated state;

FIG. 6 is a side view schematically illustrating a structure of a sheet separating apparatus of a second embodiment;

FIG. 7 is a view illustrating a magnetic circuit of the sheet separating apparatus of the second embodiment;

FIG. 8 is a view schematically illustrating a basic structure of a magnetic circuit;

FIG. 9 is a view schematically illustrating a basic structure of another magnetic circuit different from that in FIG. 8;

FIG. 10 is a view for explaining a first step in the magnetic circuit in FIG. 9; and

FIG. 11 is a view for explaining a second step in the magnetic circuit in FIG. 9.

### DESCRIPTION OF EMBODIMENTS

In the following, description will be provided on examples of embodiments of the present invention with reference to the drawings. The description in the following is simply for preferable embodiments of the present invention and is not intended to limit the scope of the present invention to the following embodiments.

<First Basic Principle>

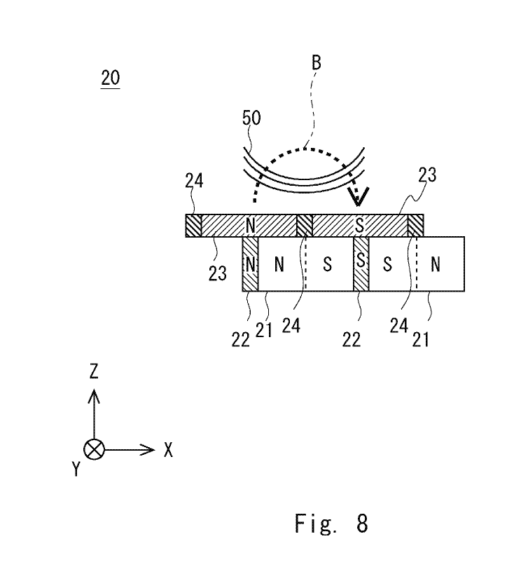

Before describing sheet separating apparatuses of the embodiments, description will be provided on a basic principle of separating sheets using a basic structure of a magnetic circuit for separating sheets. FIG. 8 is a view illustrating a basic structure of a magnetic circuit 20. The magnetic circuit 20 is arranged to generate magnetic force to separate a plurality of sheets 50. Specifically, the sheets 50 are placed above the magnetic circuit 20. Owing to magnetic force generated by the magnetic circuit 20, gaps between the sheets 50 become large at ends of the sheets 50.

The magnetic circuit 20 includes permanent magnets 21, first yokes 22, second yokes 23, and nonmagnetic members 24. In FIG. 8, two permanent magnets 21 are arranged side by side in X direction. Here, the two permanent magnets 21 are arranged with the same poles faced to each other. In FIG. 8, S poles of the two permanent magnets 21 are faced to each other.

The magnetic circuit 20 includes two first yokes 22. The two first yokes 22 are arranged at both ends of the left permanent magnet 21, respectively. Accordingly, the right first yoke 22 is arranged between the two permanent magnets 21. The two first yokes 22 control orientation of magnetic lines directing from the right permanent magnet 21 to the left permanent magnet 21.

The magnetic circuit 20 includes three nonmagnetic members 24. The right nonmagnetic member 24 and the center nonmagnetic member 24 are arranged at positions corresponding to the permanent magnets 21, respectively. In other words, each of the two nonmagnetic members 24 is arranged at a center position in X direction between an N pole and an S pole of the corresponding permanent magnet 21 (indicated by a dotted line between the N pole and the S pole in FIG. 8). That is, each nonmagnetic member 24 is arranged at the center of the corresponding permanent magnet 21 in X direction.

The second yokes 23 are arranged at positions corresponding to the first yokes 22, respectively. The second yokes 23 are larger in X direction than the first yokes 22. Accordingly, the right second yoke 23 is extended from a position corresponding to the right first yoke 22 to a position corresponding to the left permanent magnet 21. Here, each of the second yokes 23 is not extended between positions corresponding to both poles of the corresponding permanent magnet 21.

That is, the right second yoke 23 is arranged only at positions corresponding to the right first yoke 22 and the S poles of the right-left permanent magnets 21. Accordingly, magnetic force of the permanent magnets 21 arranged at both sides of the right first yoke 22 is concentrated to the right first yoke 22. Further, the concentrated magnetic force is concentrated to the right second yoke 23 that is contacted to the right first yoke 22.

Owing to that magnetic force generated at the magnetic circuit 20 is concentrated in a specific direction as described above, magnetic lines are strengthened in Z direction and reach the sheets 50 through an upper face of the second yokes 23. The sheets 50 can be curved with the magnetic force of the magnetic circuit 20. The magnetic lines B generated by the magnetic circuit 20 are parabola-shaped, so that the sheets 50 can be curved along the parabola shape. A curved amount can be varied for each of the sheets 50 by generating appropriate magnetic force, so that gaps between the sheets 50 can be enlarged at ends of the sheets 50. Accordingly, it becomes easy for an operator to hold an end of a sheet 50 with tweezers or the like. Thus, a single sheet 50 can be easily separated from the plurality of sheets 50.

First and second embodiments described in the following include magnetic circuits respectively, each magnetic circuit being modified differently from the basic structure of the abovementioned magnetic circuit 20. Here, a principle for separating a single sheet 50 from the plurality of sheets 50 of each of the first and second embodiments is substantially the same as the principle of the abovementioned magnetic circuit 20. Details of each embodiment will be described in the following.

### First Embodiment

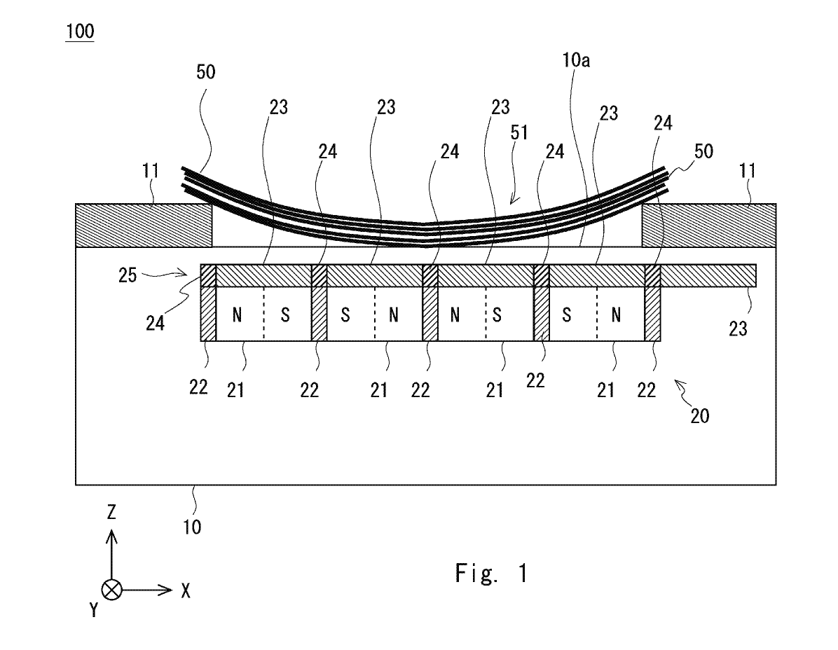

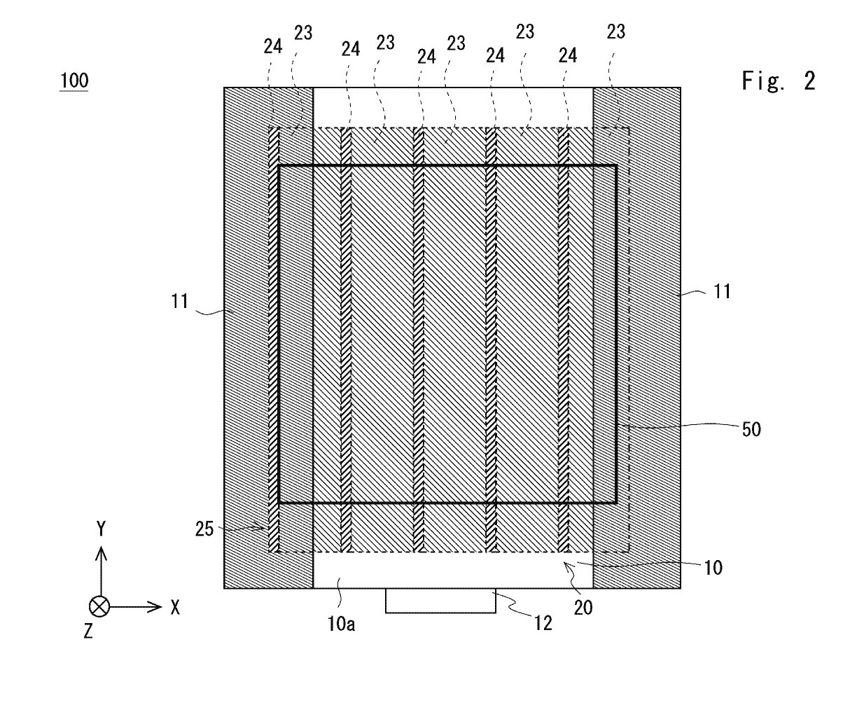

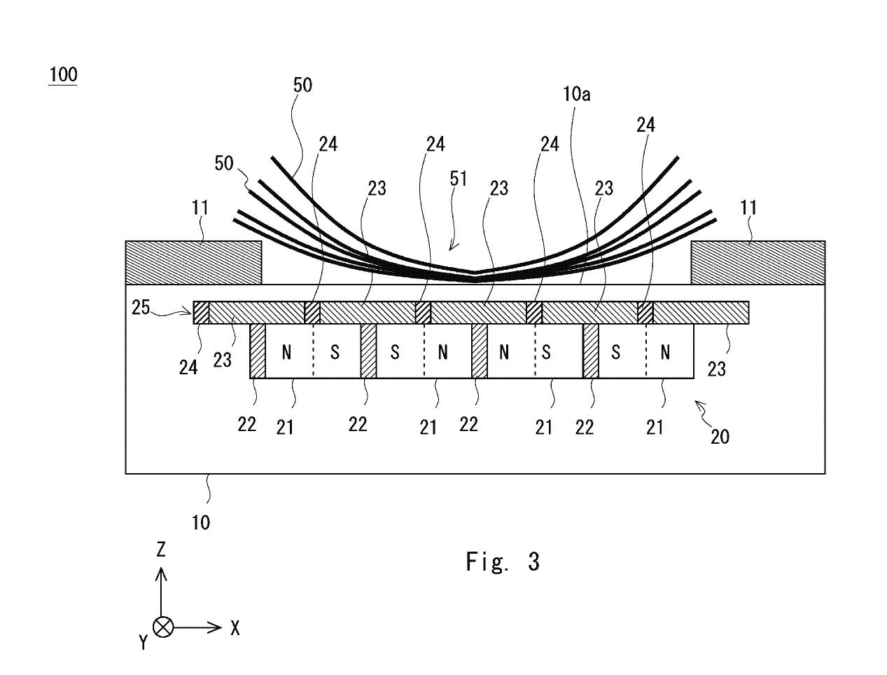

A sheet separating apparatus of a first embodiment will be described with reference to FIGS. 1 and 2. FIG. 1 is a side view schematically illustrating a structure of a sheet separating apparatus 100 of the first embodiment. FIG. 2 is a top view schematically illustrating the structure of the sheet separating apparatus 100. Here, for clarifying explanation, a three-dimensional (XYZ) orthogonal coordinate system is illustrated in the drawings. Description will be provided as assuming that Z direction is the vertical direction and X-Y directions are horizontal directions. FIGS. 1 and 3 illustrate a layered body 51 in which a plurality of sheets 50 are layered. In the following description, a non-separated state represents a state of the layered body 51 before the sheets 50 are separated as illustrated in FIG. 1. A separated state represents a state of the layered body 51 after the sheets 50 are separated as illustrated in FIG. 3.

The sheet separating apparatus 100 includes a main body portion 10, a convex portion 11, a lever 12 (see FIG. 2), and a magnetic circuit 20. The main body portion 10 is shaped like a rectangular parallelepiped box. The main body portion 10 includes a placement face 10a on which sheets 50 are placed. The placement face 10a is a flat face in parallel to the XY plane. The layered body 51 is placed on the placement face 10a, that is, placed on the +Z side (upper side) of the placement face 10a. Each sheet 50 has a size of 100 mm by 100 mm and a thickness of 10 um, for example. Five sheets 50 are layered in FIG. 1. However, the number of layered sheets 50 is not limited thereto. For example, ten sheets 50 may be layered. The sheets 50 are magnetic sheets such as SUS sheets.

The convex portion 11 is arranged at the main body portion 10 as being protruded toward +Z direction from the placement face 10a. The convex portion 11 is arranged at each of both ends of the main body portion 10. That is, two convex portions 11 are arranged on the placement face 10a as being distanced to each other in X direction. The center region of the layered body 51 is arranged on a region of the placement face 10a where the convex portion 11 is not arranged.

The distance in X direction between inner walls of the two convex portions 11 is set to be smaller than a length of the sheets 50 in X direction. Accordingly, both ends of the layered body 51 are placed on the convex portions 11. That is, as illustrated in FIG. 1, one end of the layered body 51 is placed on one of the convex portions 11 and the other end of the layered body 51 is placed on the other of the convex portions 11. The center region of the layered body 51 is placed on the placement face 10a. Accordingly, the layered body 51 is placed on the sheet separating apparatus 100 in a state that both ends thereof are bent in +Z direction. Both ends of the layered body 51 are located above the center region of the layered body 51. In FIG. 1, the plurality of sheets 50 are bent approximately in the same direction in parallel. Therefore, gaps generated between the sheets 50 are not enough to separate a single sheet 50 from the layered body 51.

As illustrated in FIG. 2, the lever 12 is arranged on a side face of the main body portion 10. As described later, the lever 12 is arranged to slidingly move a slide portion 25 of the magnetic circuit 20 along X direction.

The magnetic circuit 20 is housed in the main body portion 10. The magnetic circuit 20 includes permanent magnets 21, first yokes 22, and the slide portion 25. The slide portion 25 includes second yokes 23 and nonmagnetic members 24.

The magnetic circuit 20 includes a plurality of the permanent magnets 21. The permanent magnets 21 are arranged on the placement face 10a in line in a first direction. In FIGS. 1 and 2, X direction is set as the first direction, so that the permanent magnets 21 are arranged in X direction. Here, the first direction is not limited to X direction. A direction inclined from X direction may be set as the first direction. The permanent magnets 21 are arranged in a state that the same poles of the adjacent magnets are faced to each other. In the example illustrated in FIG. 1, regarding the first and third permanent magnets 21 from the left, S poles are arranged at +X side and N poles are arranged at −X side. Meanwhile, regarding the first and third permanent magnets 21 from the right, N poles are arranged at +X side and S poles are arranged at −X side.

According to such arrangement, the S poles are faced to each other in the permanent magnets 21 being at the first and second from the right, N poles are faced each other in the permanent magnets 21 being the second and third from the right, and S poles are faced to each other in the permanent magnets 21 being at the third and fourth from the right.

Bar magnets as illustrated in FIG. 1 may be used as the permanent magnets 21 to actualize such arrangement. However, the permanent magnets 21 are not limited to bar magnets. Further, although FIG. 1 illustrates an example that four permanent magnets 21 are arranged in line, the number of the permanent magnets 21 is not specifically limited.

The first yokes 22 are arranged at both ends of each of the permanent magnets 21. That is, the permanent magnet 21 and the first yoke 22 are arranged alternately in X direction. In FIG. 1, five first yokes 22 are arranged along X direction. The first yokes 22 control orientation of magnetic lines from the permanent magnets 21.

The slide portion 25 is arranged above the permanent magnets 21. That is, the slide portion 25 is arranged between the layered body 51 and the permanent magnets 21 in Z direction. The slide portion 25 includes the second yokes 23 and the nonmagnetic members 24. The second yokes 23 control flow of magnetic lines from the permanent magnets 21. The magnetic lines from the permanent magnets 21 cannot pass through the nonmagnetic members 24.

The nonmagnetic members 24 are arranged at positions corresponding to the first yokes 22. The second yokes 23 are arranged at positions corresponding to the permanent magnets 21. The nonmagnetic member 24 and the second yoke 23 are arranged alternately in X direction. The slide portion 25 illustrated in FIG. 1 includes five second yokes 23 and five nonmagnetic members 24.

The permanent magnets 21 and the second yokes 23 have approximately the same length in X direction. Each permanent magnet 21 and corresponding second yokes 23 are located at the same position in X direction. Further, the first yokes 22 and the nonmagnetic members 24 have approximately the same length in X direction. Each first yoke 22 and corresponding nonmagnetic member 24 are located at the same position in X direction.

According to such arrangement of the permanent magnets 21, the first yokes 22, the second yokes 23, and the nonmagnetic members 24, magnetic force from the permanent magnets 21 through the first yokes 22 can be prevented from reaching the second yokes 23 and magnetic force from the permanent magnets 21 through the second yokes 23 can be prevented from reaching the first yokes 22. Such arrangement of the slide portion 25 as illustrated in FIG. 1 is called an initial state in the following description.

The second yokes 23 are arranged between the layered body 51 and the permanent magnets 21 in Z direction. The nonmagnetic members 24 are arranged between the layered body 51 and the first yokes 22 in Z direction.

FIG. 3 is a side sectional view schematically illustrating a structure in a separated state. The slide portion 25 is arranged movably in X direction with respect to the main body portion 10. That is, the slide portion 25 slides in X direction (first direction) in the main body portion 10. Specifically, operating the lever 12 causes the slide portion 25 to slide along X direction. FIG. 3 illustrates a state that the slide portion 25 has slid. Such arrangement of the slide portion 25 as illustrated in FIG. 3 is called a slid state in the following description.

When the lever 12 is operated, the slide portion 25 is moved in −X direction from the state illustrated in FIG. 1. That is, the slide portion 25 is shifted from the initial state to the slid state, thereby the layered body 51 is shifted from the non-separated state illustrated in FIG. 1 to the separated state illustrated in FIG. 3.

In X direction, relative positions of the second yokes 23 are varied with respect to the permanent magnets 21 and the first yokes 22 and relative positions of the nonmagnetic members 24 are varied with respect to the permanent magnets 21 and the first yokes 22. From the initial state to the slid state, the slide portion 25 is moved by the amount of about a half of total length of the permanent magnet 21 and the first yoke 22 in X direction. Accordingly, the nonmagnetic members 24 are moved to positions corresponding to the permanent magnets 21. More specifically, the nonmagnetic members 24 are moved onto positions corresponding to the permanent magnets 21. In other words, each nonmagnetic member 24 is moved onto a center position between an N pole and an S pole of the corresponding permanent magnet 21 in X direction (as indicated by dotted lines in FIG. 3). The nonmagnetic members 24 are located at the center positions of the permanent magnets 21 in X direction.

Further, the second yokes 23 are moved onto the first yokes 22. The length of the second yoke 23 in X direction is larger than that of the first yoke 22. Accordingly, the second yoke 23 is extended from above the first yoke 22 to above the permanent magnet 21. Here, each second yoke 23 is not located on both poles of the permanent magnets 21. For example, the second yoke 23 being at the second from the left is located on the first yoke 22 and only S poles of the permanent magnets 21. The second yoke 23 being at the third from the left is located on the first yoke 22 and only N poles of the permanent magnets 21. Thus, each second yoke 23 is extended from above the first yoke 22 to above one pole of the permanent magnet 21. Accordingly, magnetic force of the permanent magnets 21 arranged at both sides of the first yoke 22 is concentrated on the first yoke 22, and further, the concentrated magnetic force is concentrated on the second yoke 23 in contact with the first yoke 22.

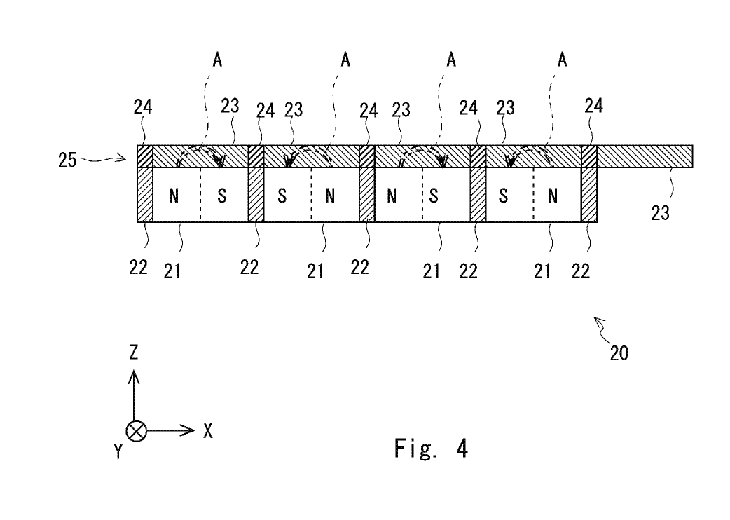

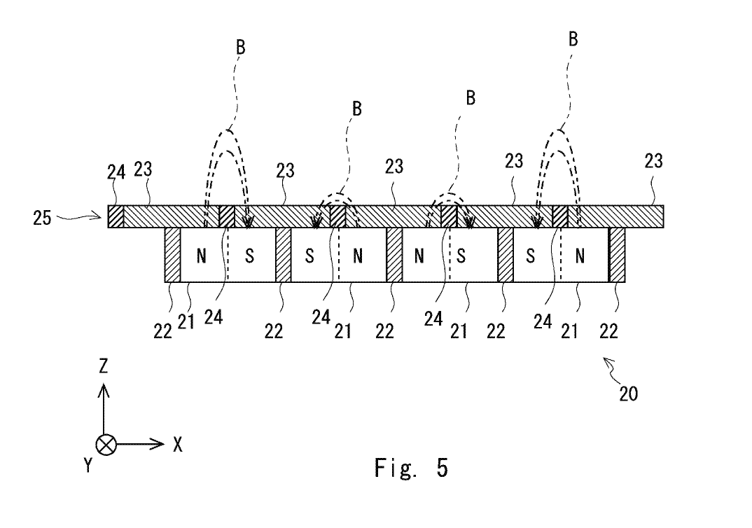

Owing to that magnetic force generated by the magnetic circuit 20 is concentrated in a specific direction as described above, magnetic lines are strengthened in Z direction and reach the layered body 51 through an upper face of the second yoke 23. Accordingly, the layered body 51 can be bent by magnetic force of the magnetic circuit 20. In the following, description will be provided on magnetic lines generated by the magnetic circuit 20 with reference to FIGS. 4 and 5. FIG. 4 is a side view illustrating a structure in the non-separated state and FIG. 5 is a side view illustrating a structure in the separated state. That is, FIG. 4 illustrates magnetic lines A in the state of FIG. 1 and FIG. 5 illustrates magnetic lines B in the state of FIG. 2.

In FIG. 4, one second yoke 23 is placed on an N pole and an S pole of one permanent magnet 21. Accordingly, the magnetic lines A from the permanent magnets 21 pass through the inside of the second yokes 23. That is, the magnetic lines A exiting from the N poles of the permanent magnets 21 return to the S poles of the permanent magnets 21 through the inside of the second yokes 23. Therefore, magnetic force does not occur above the slide portion 25, so that magnetic force is not exerted to the layered body 51.

In contrast, in FIG. 5, one second yoke 23 is placed on the same poles of the two permanent magnets 21. For example, the second yoke 23 being at the third from the left is extended from above the N pole of the permanent magnet 21 being at the second from the left to above the N pole of the permanent magnet 21 being at the third from the left. The nonmagnetic member 24 is arranged between the adjacent two second yokes 23. The magnetic lines B do not pass through the inside of the nonmagnetic member 24. The magnetic lines B exiting from the N poles of the permanent magnets 21 pass through upper faces of the second yokes 23 and return to the S poles of the permanent magnets 21 after passing over the nonmagnetic members 24. Trajectories of the magnetic lines B are parabola-shaped. Accordingly, magnetic lines B reach the layered body 51 from above the slide portion 25, so that magnetic force is exerted to the layered body 51.

In the magnetic circuit 20, three or more of the permanent magnets 21 are arranged in line in X direction. Here, magnetic force of the permanent magnets 21 placed at the center region of the placement face 10a is set smaller than that of the two permanent magnets 21 places at both end sides of the placement face 10a. That is, magnetic force of the two permanent magnets 21 placed at both end sides of the placement face 10a is set larger than that of magnetic force of the two permanent magnets 21 placed at the center region of the placement face 10a. Owing to that magnetic force is appropriately generated by three or more permanent magnets 21, magnetic force to be exerted on end regions of the sheets 50 is larger than magnetic force to be exerted on the center region of the sheets 50. Accordingly, the sheets 50 can be appropriately bent. According to the above, since gaps between the sheets 50 can be enlarged at the ends of the sheets 50, a single sheet 50 can be easily separated from the layered body 51.

Here, it is also possible that, in a state that the slide portion 25 is in the slid state, magnetic force of the permanent magnets 21 placed at the center region of the placement face 10a is set so that magnetic lines thereof do not reach or slightly reach the layered body 51. Alternatively, it is also possible that the magnetic circuit 20 has only the rightmost permanent magnet 21 illustrated in FIG. 4 without having the rest of the permanent magnets 21.

Further, in the first embodiment, a single layered body 51 may be placed at each of the permanent magnets 21. That is, a plurality of layered bodies 51 may be arranged on the placement face 10a. In this case, magnetic force of each permanent magnet 21 is adjusted so that a single sheet 50 can be separated from each layered body 51 when the slide portion 25 is in the slid state.

In the slid state (separated state) illustrated in FIGS. 3 and 5, magnetic force is exerted on the layered body 51. Accordingly, as illustrated in FIG. 3, ends of the layered body 51 are lifted. That is, bend of the layered body 51 becomes large, so that the layered body 51 is to be apart from the convex portions 11. Here, the sheets 50 have different curvature, respectively. The uppermost sheet 50 has the largest curvature. The sheet 50 at the lower side has smaller curvature. Accordingly, gaps are generated between the sheets 50 at the ends of the layered body 51 to be in the separated state in which a sheet 50 is separated from the layered body 51.

In the separated state, the sheets 50 can be separated one by one from the layered body 51. That is, for tearing-up a sheet 50, it is prevented, in the separated state, to tear up two or more sheets 50 at the same time. It becomes easier to hold an end of a sheet 50 with tweezers or the like. According to the sheet separating apparatus 100 of the present embodiment, a single sheet 50 can be easily separated from the layered body 51. Thus, the sheets 50 can be easily picked up one by one from the layered body 51.

Lift amounts of the sheets 50 with respect to the main body portion 10 can be adjusted by magnitude of the magnetic force and the like. It is also possible to adjust magnetic force by adjusting sizes of the first yokes 22 and the second yokes 23. The lift amounts may be adjusted by a slide amount of the slide portion 25. Here, it is preferable that the process is performed under conditions of time and magnetic force not to cause the sheets 50 to be magnetized. Although strength of magnetic lines varies with the kind of permanent magnets such as ferrite and neodymium, any kind of magnets can be used in principle.

In the following, description will be provided on a sheet separating method using the sheet separating apparatus 100 of the present embodiment. First, the layered body 51 is placed on the sheet separating apparatus 100 in a non-separated state as illustrated in FIGS. 1 and 4. In the non-separated state, with respect to X direction, the nonmagnetic members 24 are located at positions corresponding to the first yokes 22 and the second yokes 23 are located at positions corresponding to the permanent magnets 21.

The layered sheets 50 are in a bent state as illustrated in FIG. 1. Both ends of the layered body 51 in X direction are located above the convex portions 11. The center region of the layered body 51 in X direction is located on the placement face 10a of the main body portion 10. In the non-separated state, since magnetic force does not reach the layered body 51, the sheets 50 can be easily conveyed.

In specific sense, the non-separated state represents a state that gaps between the sheets 50 are narrowed with the sheets 50 of the layered body 51 being approximately in parallel to one another. Further, the separated state represents a state that gaps between the sheets 50 are widened with the sheets 50 of the layered body 51 bent at different angles respectively with magnetic force of the magnetic circuit 20. When the layered body 51 is in the separated state, the sheets 50 can be easily separated one by one from the layered body 51.

Then, the slide portion 25 is slidingly moved with respect to the placement face 10a along X direction (first direction) by the lever 12 being rotated by a user, a motor, or the like. Accordingly, the layered body 51 becomes into the separated state as illustrated in FIGS. 3 and 5. In the separated state, with respect to X direction, the nonmagnetic members 24 are located at corresponding positions, each position being between both poles of each permanent magnet 21 and the second yokes 23 are located at positions corresponding to the first yokes 22. Here, magnetic force generated by the magnetic circuit 20 is exerted on the layered body 51. Accordingly, gaps are generated between the sheets 50 at ends of the layered body 51, thereby the sheets 50 can be easily separated one by one from the layered body 51.

When the above process is completed, the lever 12 is rotated to return into the initial state. In the non-separated state, with respect to X direction, the nonmagnetic members 24 are located at positions corresponding to the first yokes 22 and the second yokes 23 are located at positions corresponding to the permanent magnets 21. Thus, the layered body 51 returns into the non-separated state. Here, the magnetic lines A return from N poles to S poles of the permanent magnets 21 through the second yokes 23. Accordingly, unnecessary magnetic force can be prevented from reaching the layered body 51.

The sheet separating method of the first embodiment may also be adopted to a method for manufacturing a sheet-shaped secondary cell. For example, the sheets 50 are picked up one by one with tweezers or the like from the layered body 51 in a state that a single sheet 50 is separated from the layered body 51 by the sheet separating apparatus 100. Then, the sheets 50 picked up one by one are conveyed to another manufacturing apparatus. Alternatively, electrodes, insulating material, and the like are arranged between the sheets 50 in a state that a single sheet 50 is separated from the layered body 51 by the sheet separating apparatus 100. Thus, sheet-shaped secondary cells can be manufactured at high productivity.

### Second Embodiment

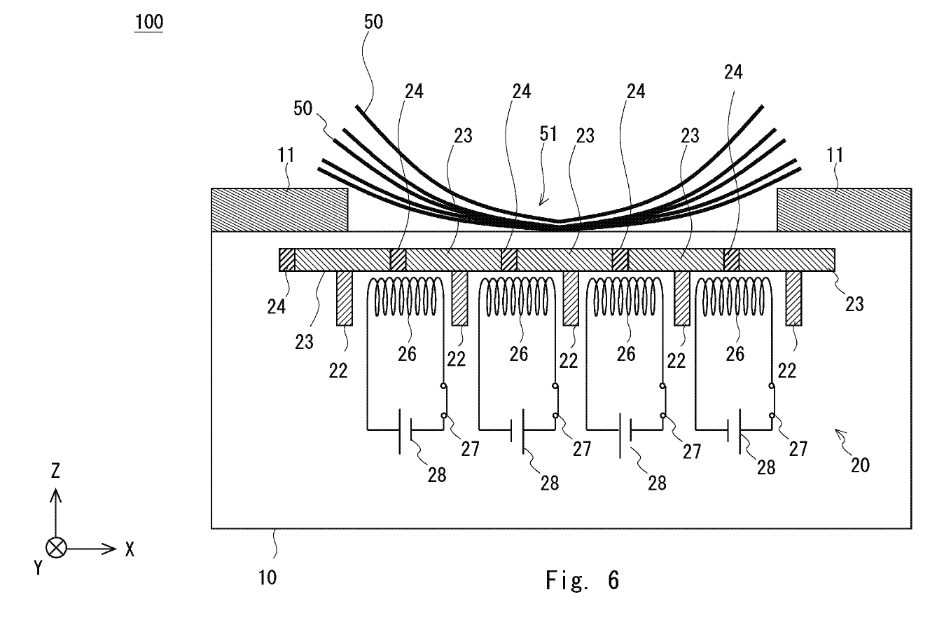

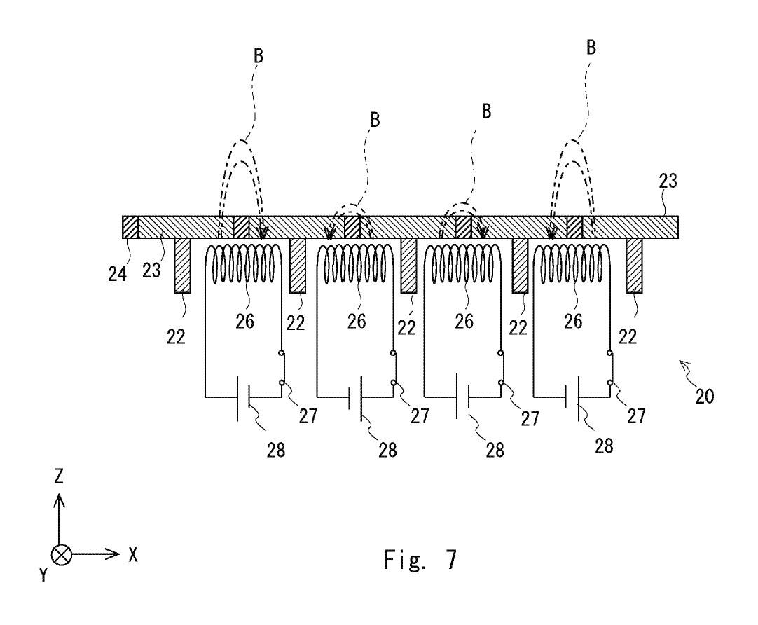

A sheet separating apparatus 100 of a second embodiment will be described with reference to FIGS. 6 and 7. FIG. 6 is a side view schematically illustrating a structure of the sheet separating apparatus 100. FIG. 7 is a view illustrating magnetic lines of a magnetic circuit 20. Here, since the basic structure of the sheet separating apparatus 100 is similar to that of the first embodiment, description thereof will be appropriately skipped. In the present embodiment, the permanent magnets 21 in the first embodiment are replaced by electric magnets 26. Since magnetic lines are to be generated by the electric magnets 26, the slide portion 25 may not be needed.

The electric magnets 26 are arranged respectively between the first yokes 22. The electric magnets 26 are solenoid coils with axes thereof oriented in X direction. In X direction, one end of each electric magnet 36 serves as an S pole and the other end thereof serves as an N pole. Each electric magnet 26 is connected to a power source 28 via a switch 27. Regarding the adjacent electric magnets 26, directions of current flow are opposite to each other, that is, connections to a positive electrode and a negative electrode of the corresponding power source 28 are opposite to each other. Thus, the electric magnets 26 are arranged in a state that the same poles are faced to each other.

The magnetic lines B being similar to those in the first embodiment can be generated by flowing current from the power sources 28 to the electric magnets 26. Accordingly, similarly to the first embodiment, the sheets 50 can be easily separated one by one from the layered body 51. Further, the separated state and the non-separated state can be switched only by ON/OFF operation of the switches 27, so that a mechanism to slide the second yokes 23 and the nonmagnetic members 24 becomes unnecessary. Accordingly, the apparatus structure can be simplified. Here, lift amounts of the sheets 50 may be adjusted by adjusting current values flowing from the power sources 28 to the electric magnets 26.

In the following, description will be provided on a sheet separating method using the sheet separating apparatus 100 of the present embodiment. First, the layered body 51 is placed on the sheet separating apparatus 100 in a state that the switches 27 are kept OFF. Both ends of the layered body 51 in X direction are located above the convex portions 11. The center region of the layered body 51 in X direction is located on the placement face 10a of the main body portion 10. Here, the layered body 51 is in the non-separated state.

Then, current having a predetermined value is flown to each electric magnet 26 by turning on each switch 27. Accordingly, the layered body 51 becomes into the separated state as illustrated in FIGS. 6 and 7. Magnetic lines B are generated above the placement face 10a. Magnetic force generated by the magnetic circuit 20 is exerted on the layered body 51. Accordingly, gaps are generated between the sheets 50 at ends of the layered body 51, thereby the sheets 50 can be easily separated one by one from the layered body 51. When separation of the layered body 51 is completed, it is simply required to turn off the switches 27. Thus, unnecessary magnetic force can be prevented from reaching the layered body 51. Similarly to the first embodiment, the sheet separation method of the present embodiment can also be adopted to a cell manufacturing method.

In the magnetic circuit 20, three or more of the electric magnets 26 are arranged in line in X direction. Either or both of setting current values flowing the electric magnets 26 and setting the number of turns of the coils of the electric magnets 26 are performed so that magnetic force of the electric magnets 26 placed at the center region of the placement face 10a is set smaller than that of the electric magnets 26 placed at both end sides of the placement face 10a. Here, pulse current may be flown to the electric magnets 26. Temporal average current values can be controlled by adjusting pulse widths of current, so that magnitude of magnetic force can be varied.

In FIG. 6, magnetic force of the two electric magnets 26 placed at both end sides of the placement face 10a is set larger than magnetic force of the two electric magnets 26 placed at the center region of the placement face 10a. Specifically, the magnetic circuit 20 is designed as adopting either or both of setting current to be flown to the electric magnets 26 at both end sides of the placement face 10a higher than current to be flown to the electric magnets 26 placed at the center region of the placement face 10a and setting the number of turns of coils of the electric magnets 26 placed at both end sides of the placement face 10a larger than the number of turns of coils of the electric magnets 26 placed at the center region of the placement face 10a.

Owing to that magnetic force is appropriately generated by three or more electric magnets 26, magnetic force to be exerted on end regions of the sheets 50 is larger than magnetic force to be exerted on the center region of the sheets 50. Accordingly, the sheets 50 can be appropriately bent. According to the above, since gaps between the sheets 50 can be enlarged at the ends of the sheets 50, a single sheet 50 can be easily separated from the layered body 51.

In the above embodiments, the placement face 10a is a horizontal face being in parallel to the XY plane. However, the placement face 10a is not limited to the horizontal face. The placement face 10a may be a plane inclined from the horizontal face or a vertical face being in parallel to the vertical direction. In this case, it is simply required to arrange a mechanism to hold the sheets 50 on the placement face 10a. Further, although the convex portions 11 are arranged for both ends of the sheets 50, the convex portion 11 may be arranged only for one end of the placement face 10a. In this case, separation can be performed only at one end of the sheets 50.

Further, for example, in the second embodiment, the slide portion 25 may not be eliminated. In this case, magnetic force for separating sheets 50 from the layered body 51 can be generated while suppressing a slide amount of the slide portion 25 and heat values of the electric magnets 26.

Further, in the first embodiment, combination of the first direction in which the permanent magnets 21 are arranged, magnetic force of the permanent magnets 21, and a slide amount of the slide portion 25 may be varied in consideration of material and the like of the sheets 50. For example, in a case that material of the sheets 50 has low magnetic susceptibility, magnetic force of the permanent magnets 21 arranged at the end sides of the placement face 10a may be set larger and a slide amount may be set larger than in a case that material of the sheets 50 has high magnetic susceptibility. In contrast, in a case that material of the sheets 50 has high magnetic susceptibility, the magnetic force may be set smaller and the slide amount may be set smaller than in a case that material of the sheets 50 has low magnetic susceptibility.

According to the above, since appropriate magnetic force without causing the sheets 50 to be magnetized can be set in accordance with magnetic susceptibility of material of the sheets 50, the sheets 50 can be effectively separated from the layered body 51.

Further, in the second embodiment, combination of the first direction in which the electric magnets 26 are arranged, values of current to be flown to the electric magnets 26, and a slide value of the slide portion 25 may be varied in consideration of the sheet remaining number of the layered body 51 and the like. For example, current to be flown to the electric magnets 26 and the slide value may be lessened with decrease of the sheet remaining number of the layered body 51. According to the above, since strong magnetic field is not applied to the ends of the layered body 51 having a small sheet remaining number, the sheets 50 can be effectively separated from the layered body 51.

Further, in the second embodiment, current to be flown to the electric magnets 26 placed at the center region of the placement face 10a may be adjusted to set magnetic force thereof so that magnetic lines thereof does not reach or slightly reach the layered body 51. Alternatively, it is also possible that the magnetic circuit 20 has only the rightmost electric magnet 26 in FIG. 7 without having the rest of the electric magnets 26.

Further, in the second embodiment, a single layered body 51 may be placed at each of the electric magnets 26. That is, a plurality of layered bodies 51 may be arranged on the placement face 10a. In this case, current to be flown to each electric magnet 26 may be adjusted so that a single sheet 50 can be separated from each layered body 51.

<Second Basic Principle>

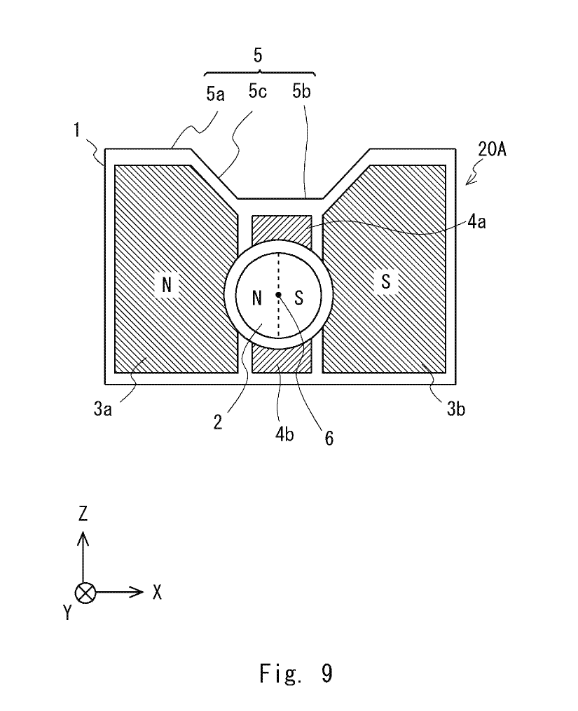

Next, description will be provided, with reference to FIG. 9, on a magnetic circuit for separating sheets 50 having a basic principle different from that in FIG. 8. FIG. 9 is a view illustrating a magnetic circuit 20A having the basic principle different from that of the magnetic circuit 20 of FIG. 8.

The magnetic circuit 20A is housed in a main body portion 1. The main body portion 1 is a hollow case and is made of material so as not to disturb magnetic force generated by a permanent magnet 2 arranged therein. The main body portion 1 includes a placement face 5 on which sheets 50 are to be placed. More specifically, the placement face 5 has end sections 5a on which ends of the sheets 50 are placed, and a center section 5b on which a center region of the sheets 50 is placed. Further, taper sections 5c are arranged from the end sections 5a to the center section 5b. That is, the sectional shape of the placement face 5 along XZ direction is concaved as illustrated in FIG. 9.

The magnetic circuit 20A includes the permanent magnet 2, a first yoke 3a arranged at one end side of the permanent magnet 2, a second yoke 3b arranged at the other end side thereof, a first nonmagnetic member 4a arranged at an upper end side thereof, and a second nonmagnetic member 4b arranged at a lower end side thereof.

As illustrated in FIG. 9, the first yoke 3a and the second yoke 3b are arranged to be faced to each other along X direction as sandwiching the permanent magnet 2. The first yoke 3a is arranged on −X side and the second yoke 3b is arranged on +X side with respect to the permanent magnet 2.

The first nonmagnetic member 4a and the second nonmagnetic member 4b are arranged to be faced to each other along Z direction as sandwiching the permanent magnet 2. The first nonmagnetic member 4a is arranged at +Z side and the second nonmagnetic member 4b is arranged at −Z side with respect to the permanent magnet 2.

The permanent magnet 2 has a cylindrical shape with the axial direction thereof oriented in Y direction. In FIG. 9, a left half serves as an N pole and a right half serves as an S pole. The permanent magnet 2 is housed in the main body portion 1 to be capable of being rotated about a rotation axis 6 being along a first direction of the placement face 5 in a state of being surrounded by the first yoke 3a, the second yoke 3b, the first nonmagnetic member 4a, and the second nonmagnetic member 4b. Here, for example, the first direction represents a direction being parallel to Y direction or a direction being rotated by a predetermined angle to ±X direction with respect to Y direction. When the permanent magnet 2 is rotated, positions of the N pole and the S pole are varied.

In the following, a method to separate a single sheet 50 from a plurality of sheets 50 using the magnetic circuit 20A will be described in two processes. The rotational angle of the permanent magnet 2 is different between first and second processes to be described later.

<First Process>

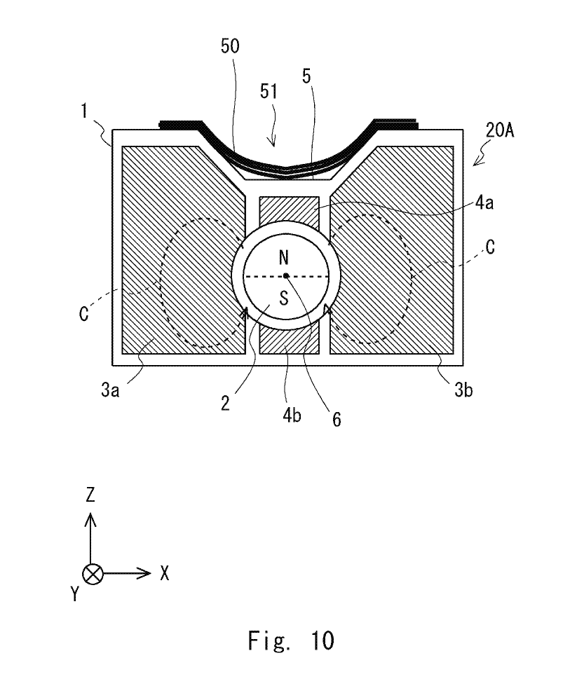

As illustrated in FIG. 10, in the first process, a layered body 51 is placed on the placement face 5 in a state that the N pole is located at a position corresponding to the first nonmagnetic member 4a arranged at the upper side and the S pole is located at a position corresponding to the second nonmagnetic member 4b arranged at the lower side. In a case that the permanent magnet 2 is located as described above, magnetic lines do not reach any of the sheets 50 without exiting from the main body portion 1. Here, the N pole and the S pole of the permanent magnet 2 are located at the upper side and the lower side, respectively. Accordingly, magnetic lines C of the permanent magnet 2 from the N pole to the S pole pass through the inside of the first yoke 3a or the second yoke 3b. Thus, magnetic lines C do not pass through the placement face 5.

In FIG. 10, although the N pole is located at the upper side of the permanent magnet 2 and the S pole is located at the lower side thereof, the N pole and the S pole may be arranged upside down. That is, it is possible that the N pole is arranged at the lower side and the S pole is arranged at the upper side. In any case, the sheets 50 is placed on the placement face 5 in a state that one pole of the permanent magnet 2 is located at a position corresponding to the first nonmagnetic member 4a and the other pole thereof is located at a position corresponding to the second nonmagnetic member 4b.

<Second Process>

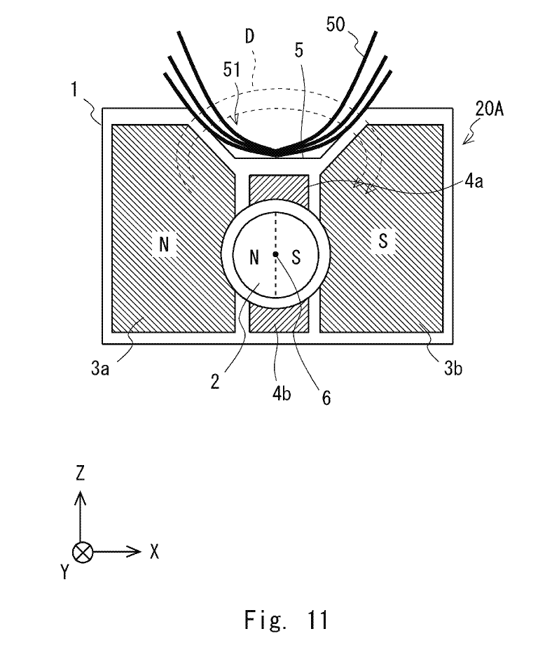

In the second process, the permanent magnet 2 is rotated counterclockwise about the rotational axis 6 by 90 degrees, so that the N pole is moved to a position corresponding to the first yoke 3a and the S pole is moved to a position corresponding to the second yoke 3b. Thus, the permanent magnet 2 becomes into a state illustrated in FIG. 11. In this state, since the N pole is strengthened by the first yoke 3a and the S pole is strengthened by the second yoke 3b, magnetic lines D from the N pole to the S pole reach the placement face 5.

According to the magnetic lines D, gaps are generated between the sheets 50. In other words, a single sheet 50 can be separated from the sheets 50 by rotating the permanent magnet 2. The taper sections 5c are arranged at the placement face 5, so that distance between the first yoke 3a and the second yoke 3b is lessened compared to a case without having the taper sections 5c. That is, since magnetic force between the first yoke 3a and the second yoke 3b can be enlarged by the taper sections 5c, larger gaps can be generated between the sheets 50.

Magnitude of magnetic force reaching above the placement face 5 can be varied by the rotational angle of the permanent magnet 2. For example, in a case that the number of the sheets 50 is small, the rotational angle of the permanent magnet 2 is set smaller than in a case that the number of the sheets 50 is large, so that magnetic force reaching above the placement face 5 can be lessened. Thus, not limited to 90 degrees, the rotational angle of the permanent magnet 2 can be set to any angle.

In the second process, the permanent magnet 2 may be rotated about the rotational axis 6 clockwise not counterclockwise by 90 degrees to move the N pole to the position corresponding to the second yoke 3b and the S pole to the position corresponding to the first yoke 3a. Even when the permanent magnet 2 is rotated as described above, since the N pole is strengthened by the second yoke 3b and the S pole is strengthened by the first yoke 3a, magnetic lines from the N pole to the S pole reach the placement face 5. Thus, in the second process, the permanent magnet 2 is rotated about the rotational axis 6 to move one pole of the permanent magnet 2 to a position corresponding to the first yoke 3a and the other pole to a position corresponding to the second yoke 3b.

The magnetic circuit 20A illustrated in FIG. 9 may be adopted in place of the magnetic circuit 20 having the permanent magnet 21 of the first embodiment and the magnetic circuit 20 having the electric magnet 26 of the second embodiment. In this case, the magnetic circuit 20A is housed in the main body portion 10 so that the rotational axis 6 is oriented in X direction of FIGS. 1 and 2 or the first direction is oriented in a direction being inclined from X direction.

In the above, description is provided on examples of the embodiments of the present invention. Here, the present invention includes appropriate modifications as long as not impairing objects and advantages thereof. Further, the present invention is not limited to the abovementioned embodiments.

This application is based upon and claims the benefit of priority from Japanese patent application No. 2015-40108, filed on Mar. 2, 2016, the disclosure of which is incorporated herein in its entirety by reference.

### REFERENCE SIGNS LIST

1 Main body portion
2 Permanent magnet
3a First yoke
3b Second yoke
4a First nonmagnetic member
4b Second nonmagnetic member
5 Placement face
5a End section
5b Center section
5c Taper section
10 Main body portion
10a Placement face
11 Convex portion
12 Lever
20 Magnetic circuit
21 Permanent magnet
22 First yoke
23 Second yoke
24 Nonmagnetic member
25 Slide portion
26 Electric magnet
27 Switch
28 Power source
50 Sheet
51 Layered body

1. A sheet separating apparatus, comprising:
a main body portion including a placement face on which a plurality of layered sheets are placed;
a convex portion that is protruded from the placement face and on which ends of the sheets are located; and a magnetic circuit arranged at the main body portion, the magnetic circuit including:
a plurality of magnets arranged in line in a first direction along the placement face with the same poles of adjacent magnets being faced to each other;
a first yoke arranged at each of both sides of each magnet;
a nonmagnetic member arranged at a position corresponding to each first yoke; and a second yoke arranged at a position corresponding to each magnet.

2. The sheet separating apparatus according to claim 1, wherein the magnets are permanent magnets, and the second yokes and the nonmagnetic yokes are arranged movably in the first direction.

3. The sheet separating apparatus according to claim 2, wherein three or more of the permanent magnets are arranged in line in the first direction, and magnetic force of the permanent magnet arranged at a center region of the placement face with respect to the first direction is smaller than magnetic force of the permanent magnet arranged at least at one end region of the placement face.

4. The sheet separating apparatus according to claim 1, wherein the magnets are electric magnets.

5. A method for separating sheets using the sheet separating apparatus according to claim 2, comprising steps of:
placing the sheets on the placement face in a state that, with respect to the first direction, the nonmagnetic member is located at a position corresponding to the first yoke and the second yoke is located at a position corresponding to the magnet; and moving the second yokes and the nonmagnetic members so that, with respect to the first direction, the nonmagnetic members are located at positions corresponding to the magnets and the second yokes are located at positions corresponding to the first yokes.

6. A method for separating sheets using the sheet separating apparatus according to claim 4, comprising steps of:
placing the sheets on the placement face; and flowing a predetermined value of current to the electric magnet.

7. The method for separating sheets according to claim 6, wherein three or more of the electric magnets are arranged in line in the first direction, and in the current flowing step, each current flowing to the three or more electric magnets is set so that magnetic force of the electric magnet arranged at a center region of the placement face with respect to the first direction is smaller than magnetic force of the electric magnet arranged at least at one end region of the placement face.

8. The method for separating sheets according to claim 6, wherein numbers of turns of coils of the three or more of electric magnets are set so that magnetic force of the electric magnet arranged at a center region of the placement face is smaller than magnetic force of the electric magnet arranged at least at one end region of the placement face.

9. A sheet separating apparatus, comprising:
a main body portion including a placement face on which a plurality of layered sheets are placed; and a magnetic circuit housed in the main body portion to be capable of causing magnetic lines to reach the sheets, the magnetic circuit including a permanent magnet, a first yoke arranged at one end side of the permanent magnet, a second yoke arranged at the other end side of the permanent magnet, a first nonmagnetic member arranged at an upper end side of the permanent magnet, and a second nonmagnetic member arranged at a lower end side of the permanent magnet.

10. The sheet separating apparatus according to claim 9, wherein the permanent magnet is rotatable about a rotational axis along a first direction on the placement face.

11. The sheet separating apparatus according to claim 10, wherein the placement face includes an end section on which an end region of the sheets is placed, a center section on which a center region of the sheets is placed, and a taper section formed at a region from the end section to the center section.

12. A method for separating sheets using the sheet separating apparatus according to claim 10, comprising:
a first step to place the sheets on the placement face in a state that one pole of the permanent magnet is located at a position corresponding to the first nonmagnetic member and the other pole of the permanent magnet is located at a position corresponding to the second nonmagnetic member; and a second step to move one pole of the permanent magnet to a position corresponding to the first yoke and the other pole of the permanent magnet to at a position corresponding to the second yoke by rotating the permanent magnet about the rotational axis.

13. A method for manufacturing a sheet-shaped secondary cell, comprising steps of:
separating the sheets with the method according to claim 5; and arranging electrodes at the separated sheet.
